(19) United States
(12) Patent Application Publication
(10) Pub. No.: US 2013/0218597 A1
(43) Pub. Date: Aug. 22, 2013

(54) DELIVERY OF ELECTRONIC MEDICAL RECORDS OR ELECTRONIC HEALTH RECORDS INTO A PERSONAL HEALTH RECORDS MANAGEMENT SYSTEM

(71) Applicants: Robert H. Lorsch, Los Angeles, CA (US); Arthur Young, Natick, MA (US)

(72) Inventors: Robert H. Lorsch, Los Angeles, CA (US); Arthur Young, Natick, MA (US)

(21) Appl. No.: 13/771,281

(22) Filed: Feb. 20, 2013

Related U.S. Application Data
(60) Provisional application No. 61/600,868, filed on Feb. 20, 2012.

(51) Int. Cl. G06F 19/00

(52) U.S. Cl. CPC G06F 19/322
USPC 705/3

(57) ABSTRACT

A method for delivery of electronic medical records or electronic health records to a personal health record portal is provided. The method includes sending an electronic health record or electronic medical record report from a health care information system to a report distribution system, distributing the report from the report distribution system to a personal health record portal accessible through a web server.

### PRIORITY STATEMENT

This application claims priority to U.S. Provisional Patent Application No. 61/600,868, filed Feb. 20, 2012, herein incorporated by reference in its entirety.

### FIELD OF THE INVENTION

The present invention relates to personal health records. More particularly, but not exclusively the present invention relates to the delivery of electronic medical records or electronic health records into a personal health record (PHR) management system.

### BACKGROUND OF THE INVENTION

Various health care information systems provide for electronic medical records (EMRs) or electronic health records (EHRs). Yet problems remain in making such records accessible to patients. What is needed are technical solutions for making such records available to patients regardless the type of health care information system.

### SUMMARY OF THE INVENTION

Therefore, it is a primary object, feature, or advantage of the invention to improve over the state of the art.

It is a further object, feature, or advantage of the present invention to make EMRs or electronic health records EHRs available to patients.

It is a still further object, feature, or advantage of the present invention to make EMRs or EHRs available to patients through a PHR portal.

One or more of these and/or other objects, features, or advantages will become apparent from the specification and claims that follow. No single embodiment need exhibit each of these objects, features, or advantages.

According to one aspect, a method for delivery of electronic medical records or electronic health records to a personal health record portal is provided. The method includes sending an electronic health record or electronic medical record report from a health care information system to a report distribution system, distributing the report from the report distribution system to a personal health record portal accessible through a web server.

According to another aspect, a method for delivery of electronic medical records or electronic health records is provided which includes receiving an electronic health record or electronic medical record report of a patient from a health care information system at a report distribution system and distributing the report from the report distribution system to a personal health record portal accessible through a web server.

According to another aspect of the present invention, a method for delivery of electronic medical records or electronic health records to a personal health record portal includes sending an electronic health record or electronic medical record report from a health care information system to a report distribution system configured to distribute the report from the to a personal health record portal accessible through a web server.

According to another aspect of the present invention, a method for delivery of electronic medical records or electronic health records to a personal health record portal is provided. The method includes sending an electronic health record or electronic medical record from a health care information system to a report distribution system, generating a report using the report distribution system, and distributing the report from the report distribution system to a personal health record portal accessible through a web server.

According yet another aspect of the present invention, a method for delivery of electronic medical records or electronic health records to a patient portal is provided. The method includes receiving an input file containing health information from a health care information system and determining a format of the input file and if the format of the input file is not a text format, converting the input file into a text format input file using a computing device. The method further includes extracting data corresponding with one or more data variables from the text format input file using the computing device, assembling a file for delivery using the data, and delivering the file for delivery to a server associated with a patient portal to thereby make the health information available at the patient portal.

According to another aspect of the present invention, a system for delivery of electronic medical records or electronic health records to a personal health record portal is provided. The system includes a report distribution system comprising instructions stored on a computer readable storage medium and executing on a computer device for performing steps of receiving an electronic health record or electronic medical record from a health care information system, generating a report, and distributing the report to a personal health record portal accessible through a web server.

### BRIEF DESCRIPTION OF THE DRAWINGS

FIG. 1 is a diagram illustrating one embodiment of a system for collecting medical records including electronic health records and/or electronic medical records and delivering the records to a personal health record management system.

FIG. 2 is a diagram illustrating another example of systems used in the process of collecting medical records in a health care information system server and delivering into a personal health record management system.

FIG. 3A and FIG. 3B is a diagram illustrating one example of a process.

FIG. 4 illustrates one example of a screen display from a personal health record solution.

FIG. 5 illustrates another example of a method.

FIG. 6 illustrates a screen display illustrating how different templates may be used for report distribution.

FIG. 7 illustrates a screen display showing template information for a report.

FIG. 8 illustrates a screen display showing report separator settings.

FIG. 9 illustrates a screen display showing template details.

FIG. 10 illustrates a screen display showing a filename template.

FIG. 11 illustrates a screen display showing that data can be transmitted in or out on defined TCP sockets.

FIG. 12 illustrates a screen display illustrating that health information can be delivered as an HL7 message.

FIG. 13 illustrates a screen display showing that transactions can be logged into one or more databases.

### DETAILED DESCRIPTION OF THE PREFERRED EMBODIMENTS

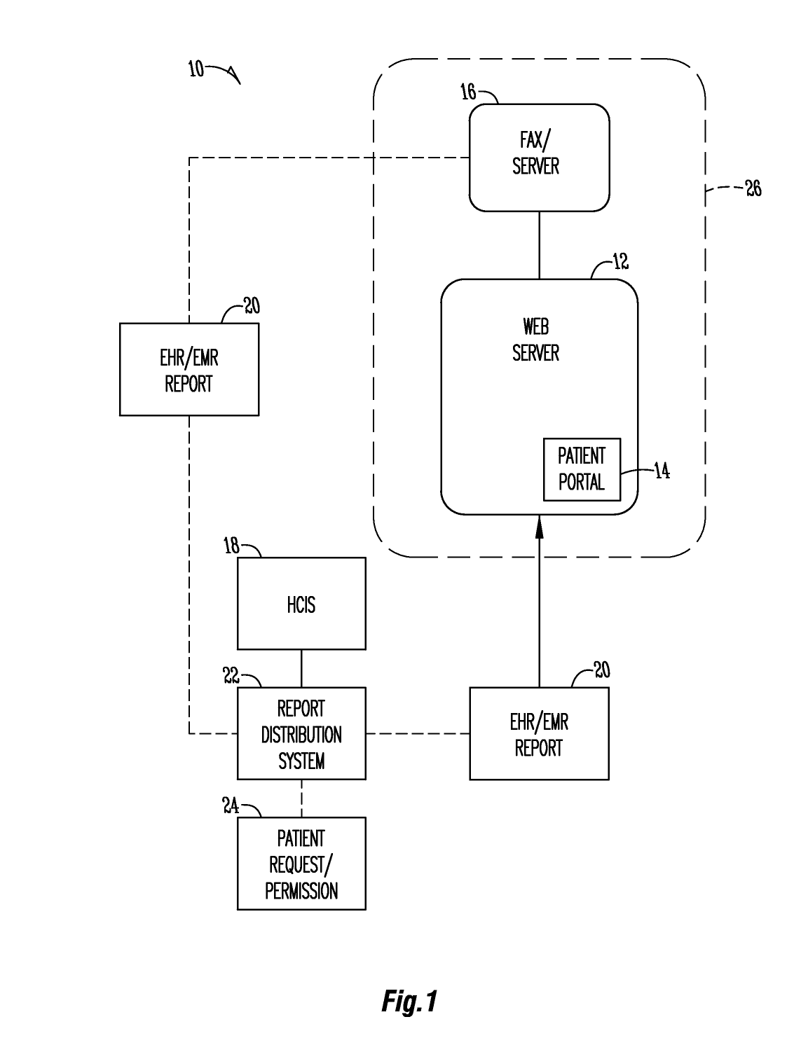

FIG. 1 is a diagram illustrating one embodiment of a system for collecting medical records including electronic health records and/or electronic medical records and delivering the records to a personal health record management system. As shown in FIG. 1, a system 10 includes a web server 12 with a patient portal 14. The web server 12 is operatively connected to a fax server 16. Also shown in FIG. 1 is a health care information system (HCIS) 18 which includes one or more computing devices. The HCIS 18 is typically associated with a health care provider such as a doctor's office, clinic, hospital, or other organization. The HCIS 18 typically uses electronic health records (EHRs) or electronic medical records (EMRs).

A report distribution system 22 is operatively connected to the HCIS 18. The report distribution system allows for reports 20 containing information from electronic health records or electronic medical records to be communicated to the fax server 16 and/or the web server 12. Thus, a patient can then access the reports 20 through the patient portal 14.

A patient may provide to the health care provider a patient request/permission form 24 which includes an email address, fax number, or other destination address and which requests that records of the patient be sent to the destination address.

The report distribution system 22 provides for converting EHRs/EMRs into a format suitable for use for viewing through the patient portal 14. For example, the report distribution system 22 may print the resulting report into an image file such as a PDF, TIFF, or other type of image file which may be sent to the web server 12. Alternatively, the report distribution system 22 may generate an XML file with the resulting report and send it to the web server 12. Alternatively, the report distribution system 22 may fax the resulting report 20 to the fax server 16. In addition, the report distribution system 22 may provide for parsing information contained within the record to generate output in different forms such as a text file, an HL7 message, or other type of format as well as creating image files containing the records.

Preferably, where the resulting report 20 is faxed to the fax server 16, the patient request/permission form 24 identifies a phone number uniquely associated with the patient so that the faxed reports can be routed to a corresponding user account of the patient portal 14.

The report distribution system 22 may be configured for each patient according to preferences specified by the patient in the request/permission form 24. This may include not only the destination address which may be indicative of type of delivery (e.g. fax or electronic) as well as format of the data (such as type of file where delivery is electronic).

The report distribution system 22 may include the NetDelivery system available from Interbit Data (Natick, Mass.). Reports may be printed to a virtual printer managed by NetDelivery and processed by a report distribution template that allows the delivery method to be to the personal health records management system 26.

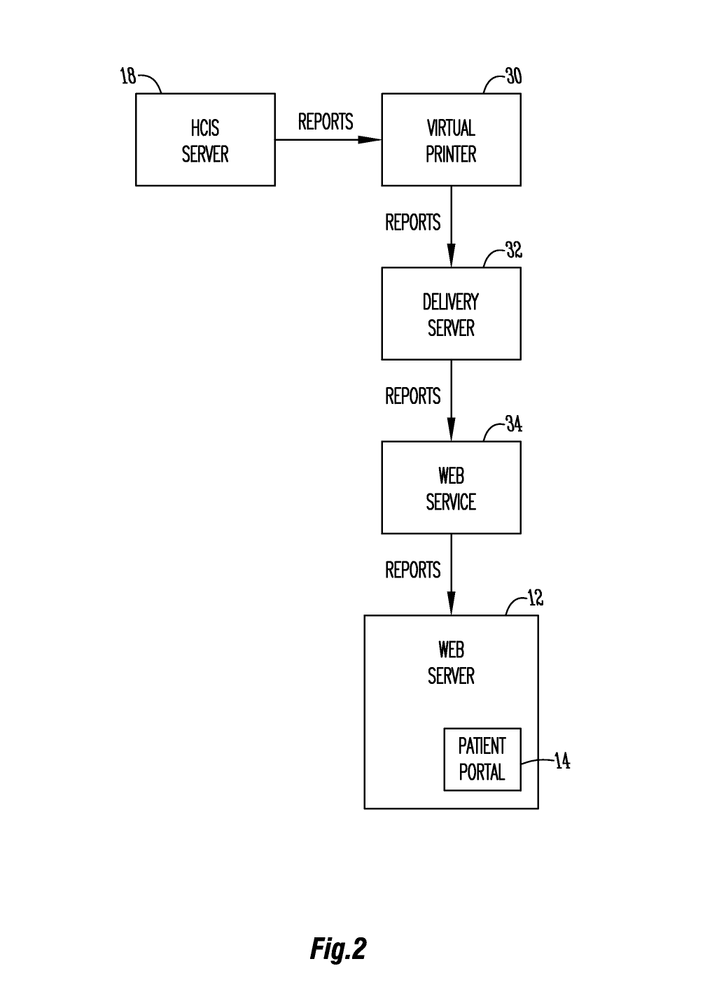

FIG. 2 illustrates one embodiment of a system where an HCIS server 18 sends reports to a virtual printer 30. The virtual printer may then in turn send reports in a format generated by the virtual printer to the delivery server 32. The delivery server 32 may communicate through a web service 34 to deliver reports to a web server 12 associated with a personal health record web site or management system. The web server 12 may include a patient portal 14 for patients to use to access their records. Thus, in this way, a universal method is provided to make EHRs/EMRs from an HCIS available to a patient portal 14. This results in patients having greater access and control over their personal health records and resolves technical issues associated with having health records in different formats in different systems so that health records can be easily, conveniently, and securely be collected into a personal health record.

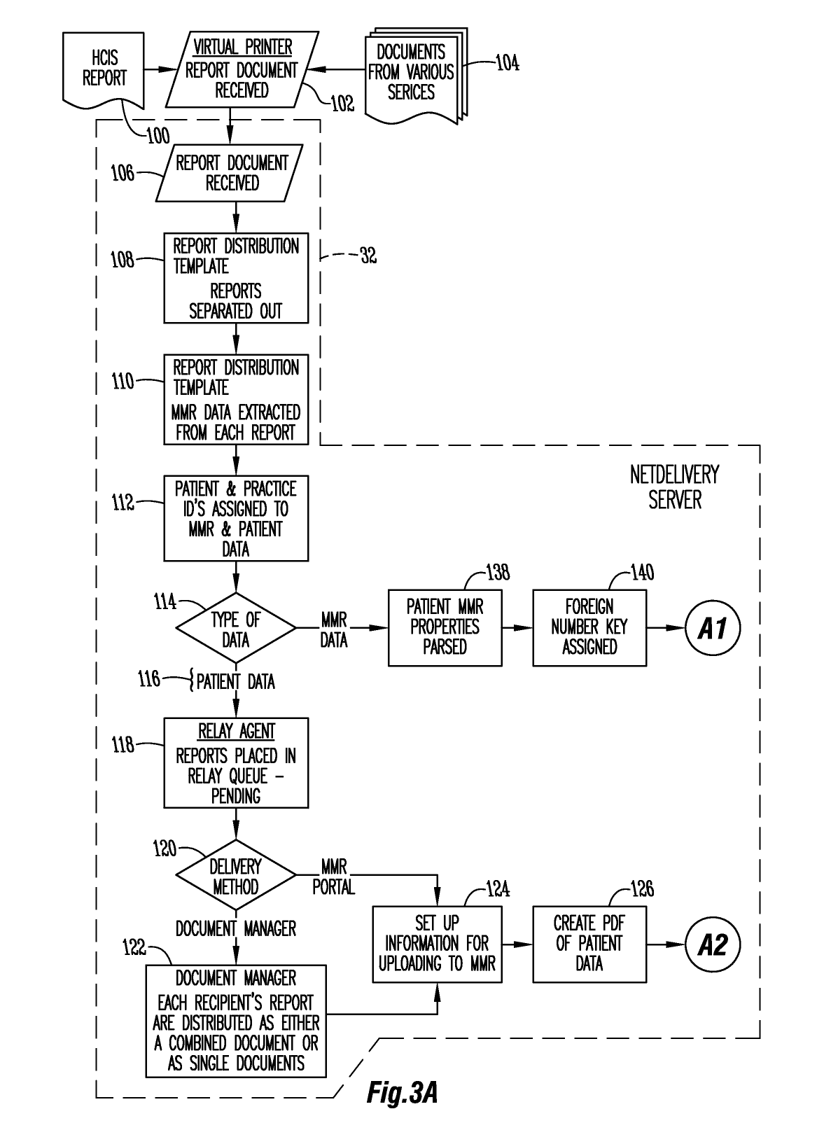

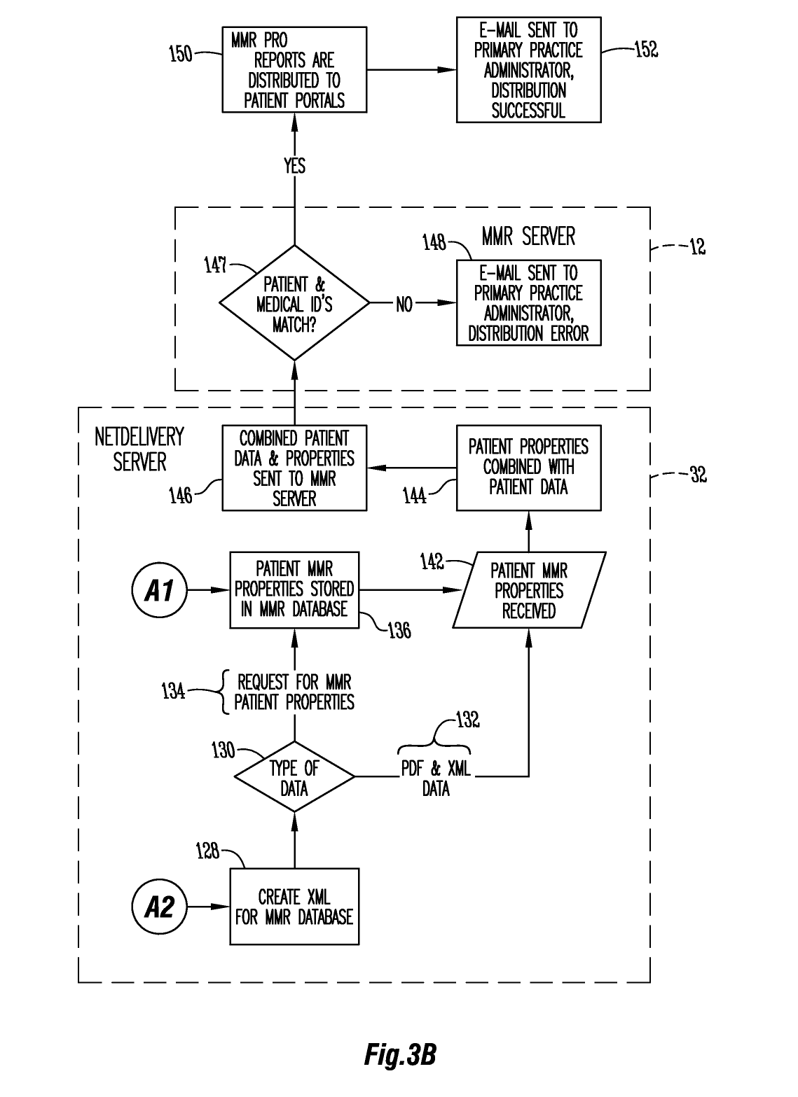

FIG. 3A and FIG. 3B illustrate one example of a process for the delivery of electronic medical records or electronic health records into a personal health records management system. In FIG. 3, a HCIS report 100 is shown. The HCIS report 100 is sent to a virtual printer 102. It is to be further understood that documents from other sources 104 may also be sent to the virtual printer 102. From the virtual printer 102 which may be implemented on software stored on a computer readable storage medium, the report or document is received in step 106. Next, in step 108, reports are separated out as specified by a report distribution template. In step 110, data associated with the PHR management system (“MMR” in this example) is extracted from each report. In step 112, patient and practice IDs are assigned to the data associated with the PHR management system as well as patient data. In step 114 a determination is made based on the type of data and different steps are followed based on the type of data. If the type of data is determined to be patient data 116 then in step 118 a relay agent is used to place reports in a relay queue. Then in step 120 a determination is made as to the type of delivery method. The type of delivery method may be to a document manager 122 in which case each recipient's reports are distributed as either a combined document or as single documents. In step 124 information is setup for uploading to the PHR management system. In step 126, a PDF of patient data (or other file format) is created and in step 128 XML for the MMR data is created. In step 130 a determination is made as to the type of data. If for example, the type of data is PDF and XML data 132 then in step 142 patient MMR properties are received. In step 144 patient properties are combined with patient data such that in step 146 combined patient data and properties may be sent to a MMR server.

Returning to step 114, if the type of data is MMR data, then in step 138, patient MMR properties are parsed. In step 140, a foreign number key is assigned and then the process continues to step 136 where patient MMR properties are stored in a database. The process then continues to step 142 which has previously been explained.

Returning to step 146, the combined patient data and properties are sent to the server 12. At the server 12, a determination is made in step 147 as to whether the patient and medical IDs match. If not, in step 148 an email or other notification may be sent to a primary practice administrator or other individual associated with the HCIS indicating that a distribution error has occurred. If there is a match in step 146, then in step 150 reports are distributed to patient portals. An email or other notification may then be sent to the primary practice administrator or other individual associated with the HCIS indicating that distribution was successful.

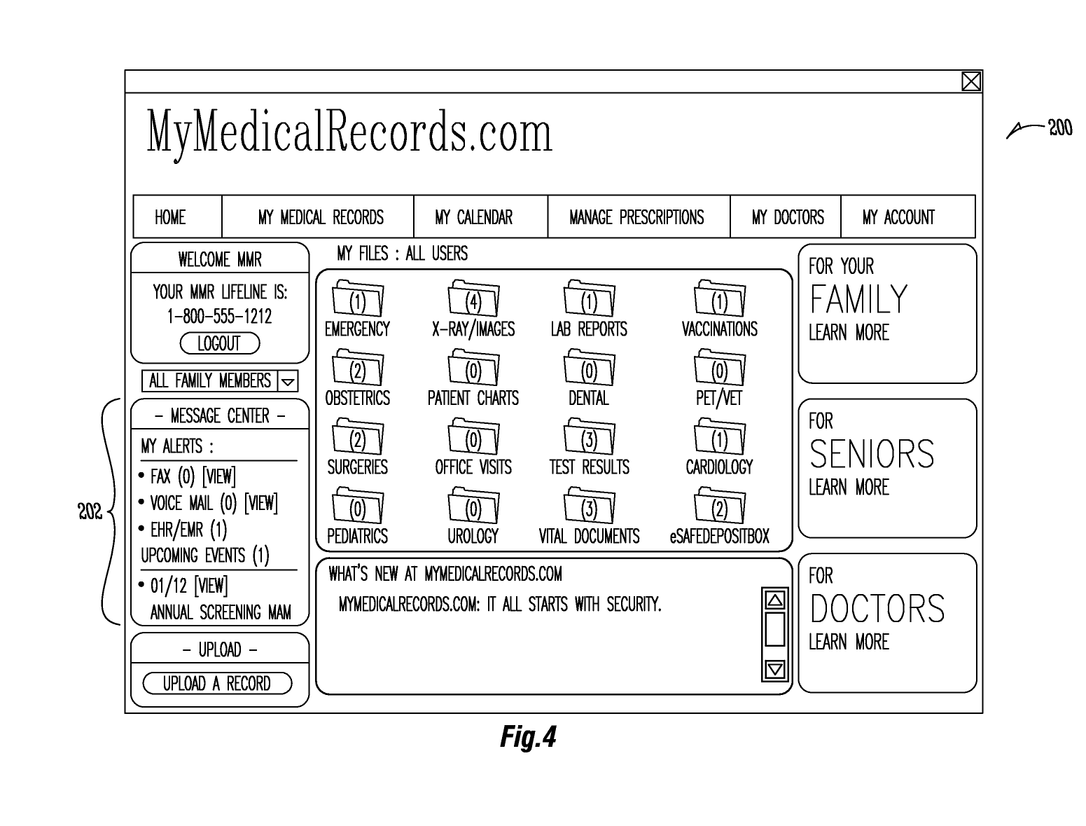

FIG. 4 illustrates one example of a view of a screen display 200 from a personal health record solution which provides for collecting, organizing, and otherwise managing personal health records. Note that in FIG. 4, a message center 202 is provided. When EHR/EMR records are available a user may be notified that the records are available. According to one example, when a hospital requests the creation of a patient portal site, the PHR solution provider (specified here as MMR) provides to the hospital and the provider of the delivery system a unique Practice ID (examples of PHR management systems are provided in U.S. Pat. Nos. 8,121,855; 8,301,466; 8,321,240; 8,117,646; 8,117,045, herein incorporate by reference). This Practice ID may be mapped to a folder on the server where reports generated by the hospital are stored. This practice ID may then become a part of the unique patient ID assigned to each patient that requests a patient portal. Patients at a hospital request that their PHR be sent to a patient portal, and provides to the hospital an e-mail address (or other destination address). Data about patients who have requested Patient Portal as a delivery method may then be extracted from the HCIS. These data fields may then be sent to NetDelivery and stored in NetDelivery's MMR database directory. The data fields may also be uploaded to MMR server where it is used to configure a patient's patient portal and stored for future reference.

When reports (e.g., Discharge Summary) are delivered to NetDelivery (via printing to a “virtual printer” managed by NetDelivery, or via other IP connection) they are processed by a report distribution template that determines whether or not the delivery method is MMRPatientPortal. If so, NetDelivery connects to the MMR server and downloads the set of patient fields. NetDelivery combines the patient data from the report with the downloaded patient fields. NetDelivery uploads the combined patient data to the MMR web service. If the upload fails, the combined patient data is sent to NetDelivery's failed queue. If the upload succeeds, the patient report is uploaded. NetDelivery uploads the patient report to the SFTP server. If the upload fails, the report is sent to NetDelivery's Failed queue. If the upload succeeds, the report is copied to NetDelivery's Completed queue.

At MMR, MMR distributes the report to the Patient Portal for the patients who requested this delivery method, sends a confirmation e-mail to the patient that a report has been received, and sends an e-mail to the NetDelivery administrator that the upload was successful. The first time that a report for a new patient is distributed to a patient portal, that patient receives an e-mail containing unique login credentials, that may include: the Practice ID, the User ID, a unique password, and the patient's date of birth. Using this information, the patient logs into the Patient portal and is prompted to change the password. The patients view the reports. If the patient has requested only the basic service, the reports are viewed on the MMRPatientView patient portal, but no modifications can be made. If the patient has purchased the enhanced portal, the reports are viewed on MMRPatientPortal. The changes can be made to the content of the patient portal. It should be understood that the example given is merely one way in which the method can be implemented.

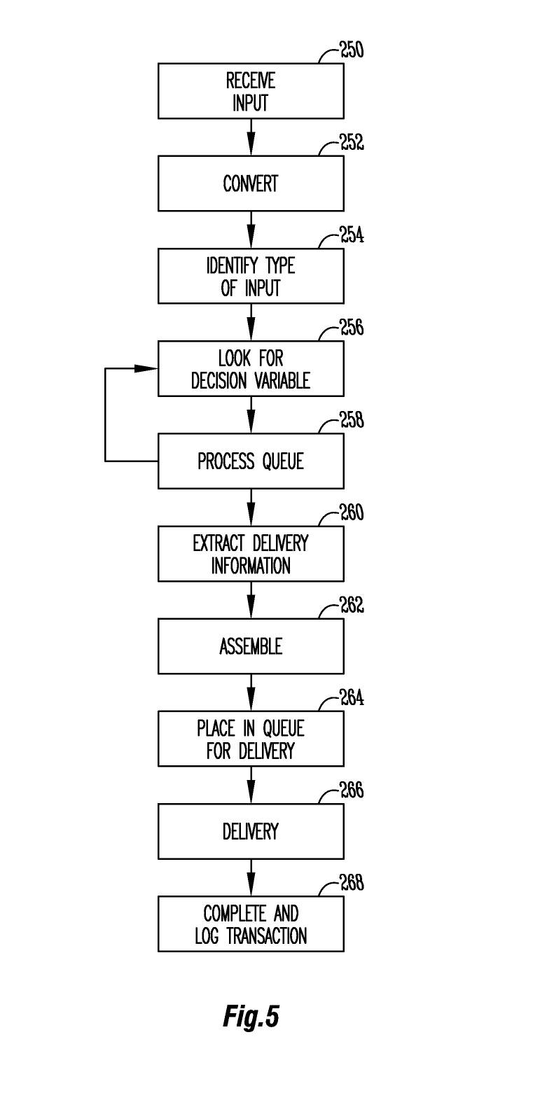

FIG. 5 is a flow chart illustrating one example of a method. In step 250, input is received. The input received may be in the form of a file. The input, may be in the form of ASCII data which may be communicated in any number of ways, such as, but not limited to, TCP socket to socket communications on any specified socket, TCP socket to socket communications via a print driver (such as a Microsoft Windows print driver), a LPR print protocol via queue on port 515 of the server, or placement of the file in a specific location monitored by the application such as placement in a directory via facsimile receipt, via an FTP process, via a scan upload, or otherwise programmatically or via user-input. Thus, it is to be understood that the input may be received in any number of different ways.

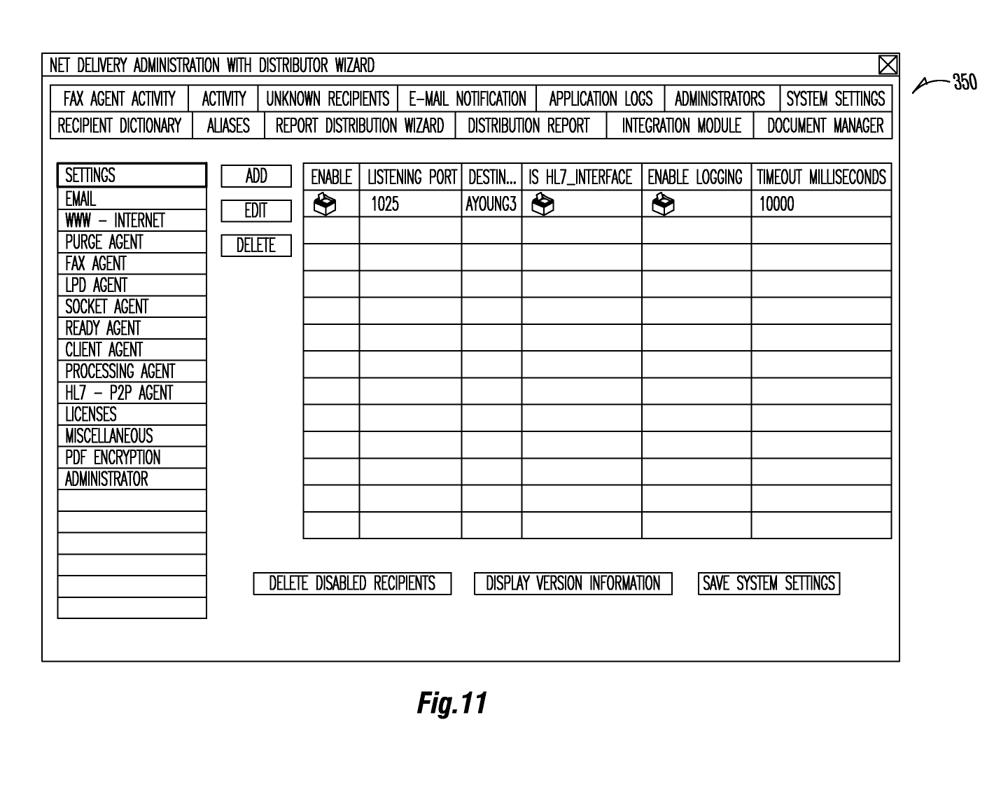

Next, in step 242 the input previously received is converted to a readable form if needed. One method of determining how to convert the input to a readable form is based on the manner in which the input is received in step 250. For example, where input is received via TCP socket to socket communications on a specified socket the data format may be additionally defined by the port number. Similarly, where the data is received via TCP socket to socket communications via a printer driver, the data format may be additionally defined by the port number. FIG. 11 illustrates a screen display 350 illustrating that data may be transmitted in or out using defined TCP sockets. Where the data is received via LPR print protocol via queue (such as on part 515 of the server), the data format may be defined by the queue name. Where the data is received by the placement of a file in a directory monitored by the application, the specific directory in which the file is placed may specify the data format. Thus, in these and/or other ways the data format of an input file can be identified. Once the data format is identified, then the data may be converted to another format such as text. If the data is already text data then the text data may be preserved as text. If the data is in a format such as HL7 then data may be extracted a readable text. If the data is in a PDF format, then PDF data is extracted as readable text, of if text is unavailable, OCR capabilities are launched to convert to text. If the received data is image data then it may be converted to text using OCR capabilities. Regardless of the type of data, the data in its form before conversion may be preserved.

Returning to FIG. 5, in step 256, the process looks for decision variables. The specific context for variables are defined in each input, allowing the system to search readable text and locate variables. The search capabilities may include one or more of preceding specific word(s), following specific word(s), after x instances of specific word(s), backward to a point, forward to a point, after a specific variable change(s), character offset, line offset, ASCII (non-printing) character(s), or compare to table for action. Thus, the method provides for locating specific variables within the input through a number of different ways.

Next in step 248 processing takes place. During initial file processing, a file may be separated into individual reports by utilizing specified decision variables contained within the document. Alternatively, the file may be searched for specific data variable(s) to move the file into other process(es). Alternatively, the file may be processed for delivery.

The process may be repeated any number of additional times as may be needed to identify additional decision variables in step 256 and perform additional processing in step 258.

In step 260, delivery information is extracted. Examples of data variables which can be extracted may include the following variables:
Practice Login ID
Practice Patient ID
First Name
Middle Name
Last Name
Gender
Blood Group
Date of Birth
Address 1
Address 2
City
State
Country
Zip
Phone 1
Phone 2
Fax Number
E-mail Address
Contact Name
Contact Phone
Insurance Type
Carrier
Group ID
Employer ID
Employee ID
Anesthesiologist
Allow E-Mail Notification
Time Zone
Language
Physician
Referring Physician Name

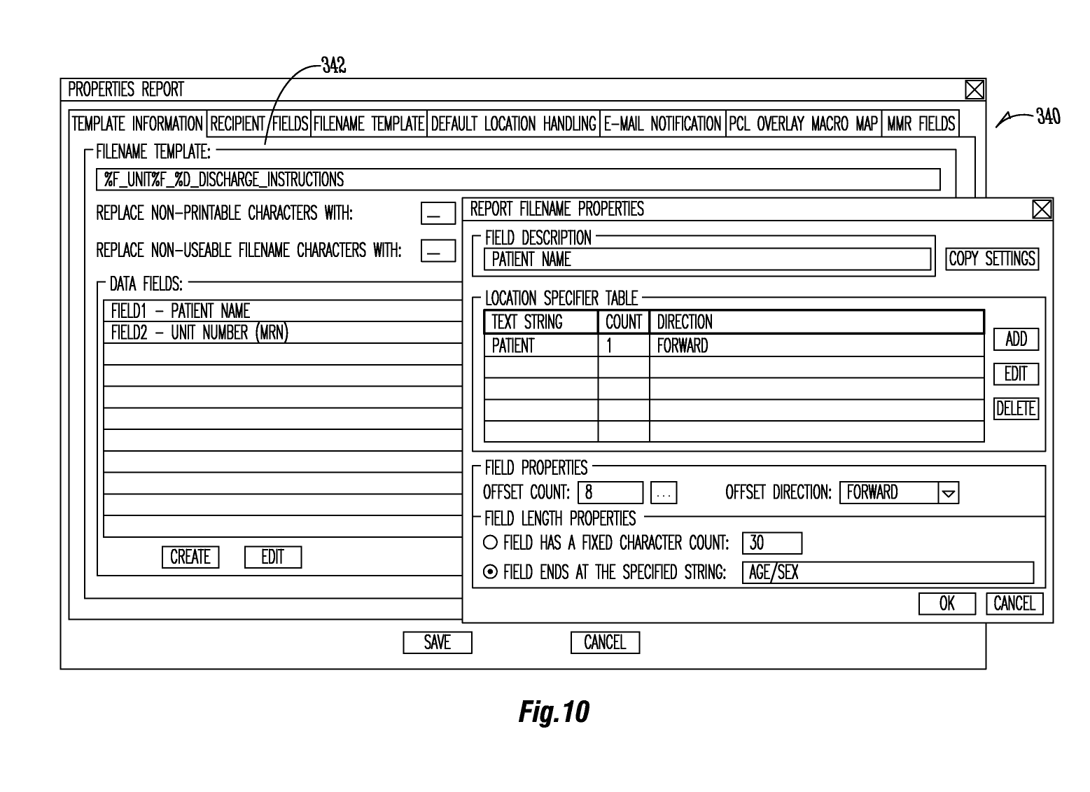

Note that the variables include information such as contact information, insurance information, basic medical information, physician information, and other types of information. In addition to the examples shown, additional variables may be extracted and can be placed in the file. It is further contemplated that there may be one or more required variables. For example, in some embodiments the practice login ID and the practice patient ID may be required for identification purposes. In addition, one or more variables may be required the first time for setup purposes, such as the e-mail address data variable. In addition, the format for a file name may be defined using the variables. FIG. 10 illustrates a screen display 340 wherein a filename template 342 is used to define a filename using the variables.

Returning to FIG. 5, in step 262, a file may be assembled and converted into a pdf (or other desired format) and placed in a queue with the desired meta data (such as the variable described above).

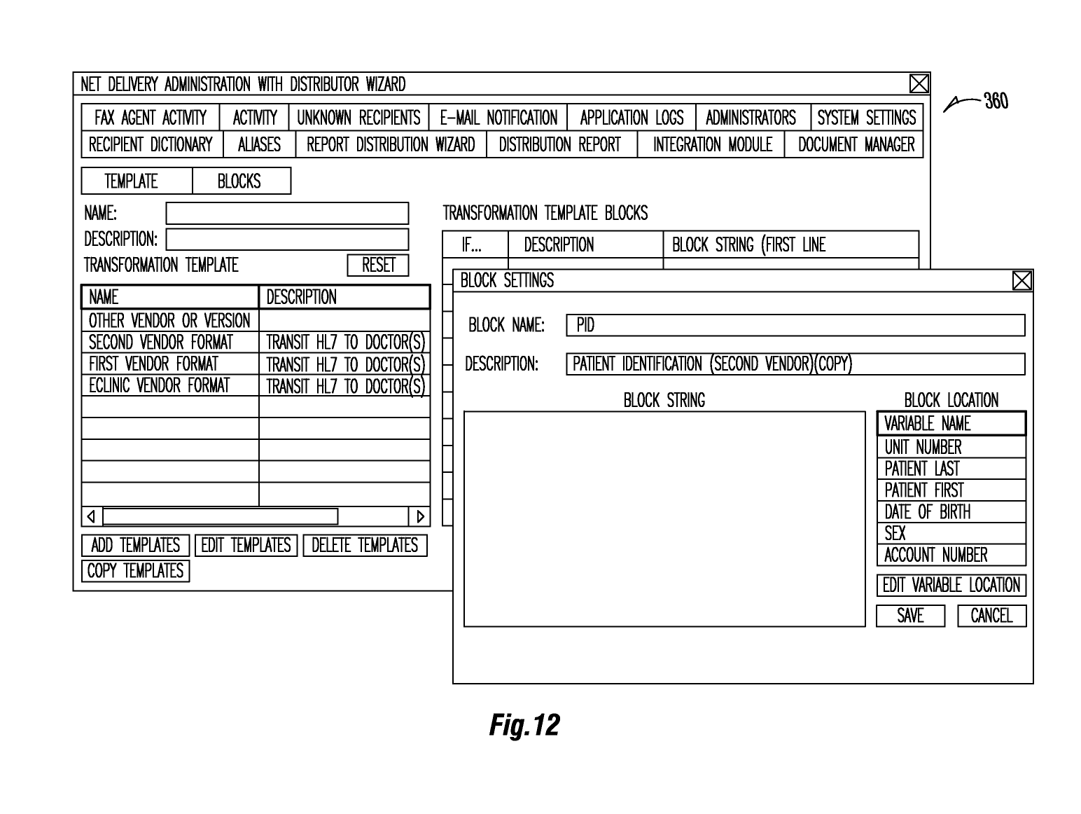

Alternatively, the meta data can be assembled into a defined HL7 message with the original file or text included as the OBX portion of the message. Data may be extracted from the file such as by using the decision variables described above to populate the MSH, PID, PV1, ORC, and ORC sections of the message. FIG. 12 illustrates one example of a screen display 360 which illustrates how messages can be delivered as HL7 messages.

It is to be understood that the method may be adapted to accommodate other types of file formats or other types of message formats as may be desired in a particular implementation.

Returning to FIG. 5, next in step 264, the resulting is file is placed in queue for delivery to the PHR portal and delivered in step 266. One form of delivery is for the file to be delivered via secure file transfer protocol (SFTP) to a host server associated with the PHR portal.

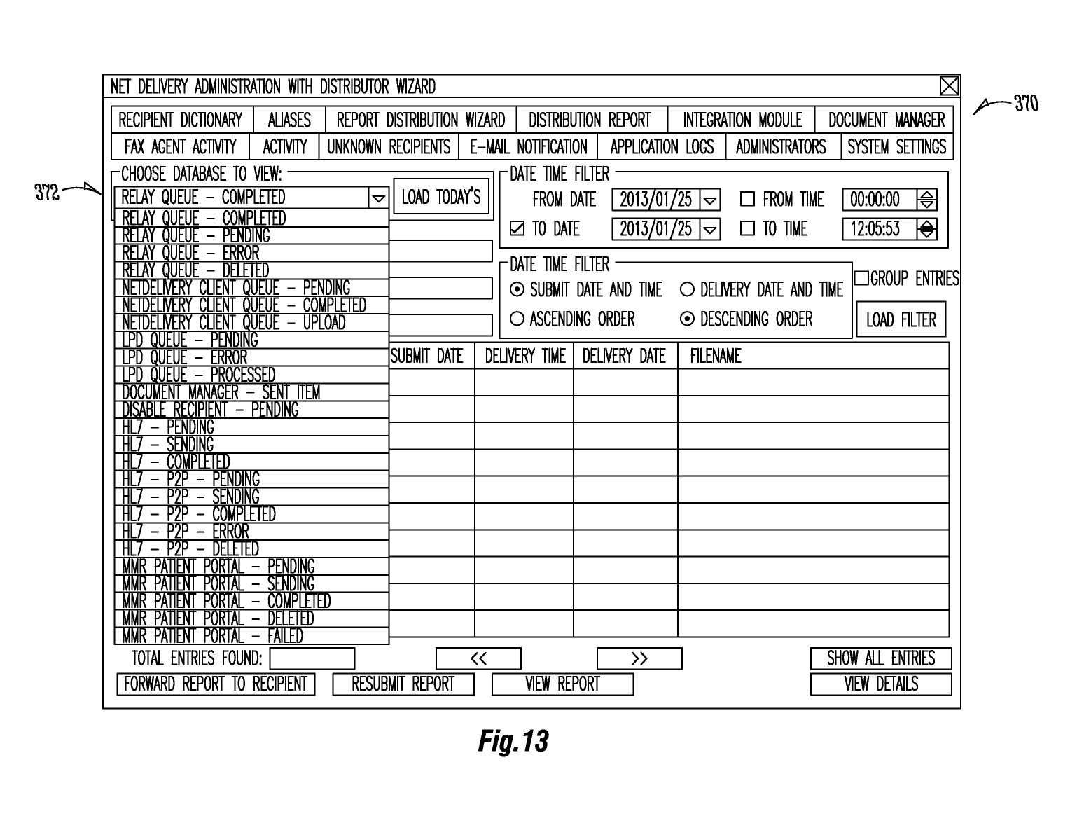

After delivery in step 266, transactions may be logged. For example, transactions may be stored within a database. Examples of information that can be stored may include received files, files which are pending processing, files which have been processed successfully, files which have failed processing, files which have been deleted, files which are pending the decision process, files which have successfully completed the decision process, files which have failed the decision processing, files which have been deleted from the decision process, unknown recipient, files pending delivery to the PHR portal, files which have been successfully delivered to the PHR portal, files which have failed delivery to the PHR portal, and files which have been deleted from the PHR queue. FIG. 13 illustrates a screen display 370 which includes a drop down list 372 of databases that can be viewed which include different transactions.

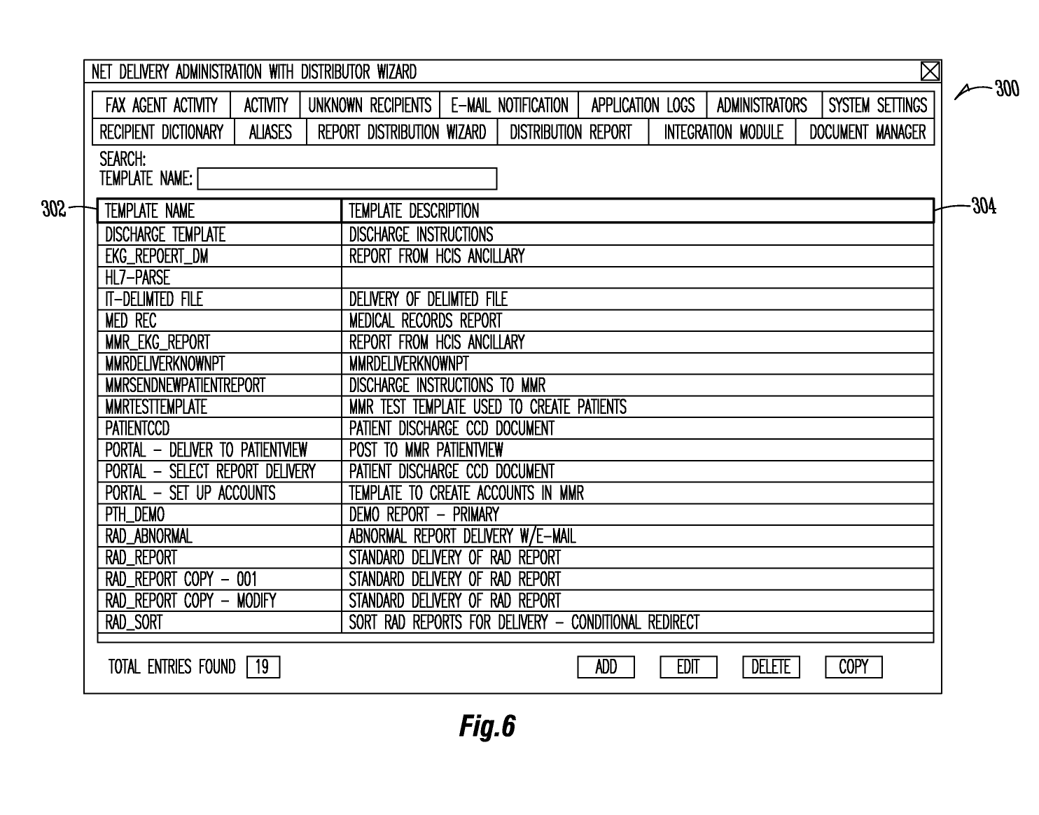

FIG. 6 illustrates a screen display 300 illustrating how different templates may be used for report distribution. A list 304 of templates and their descriptions are shown. Note that the templates include templates for delivering reports to a personal health record portal.

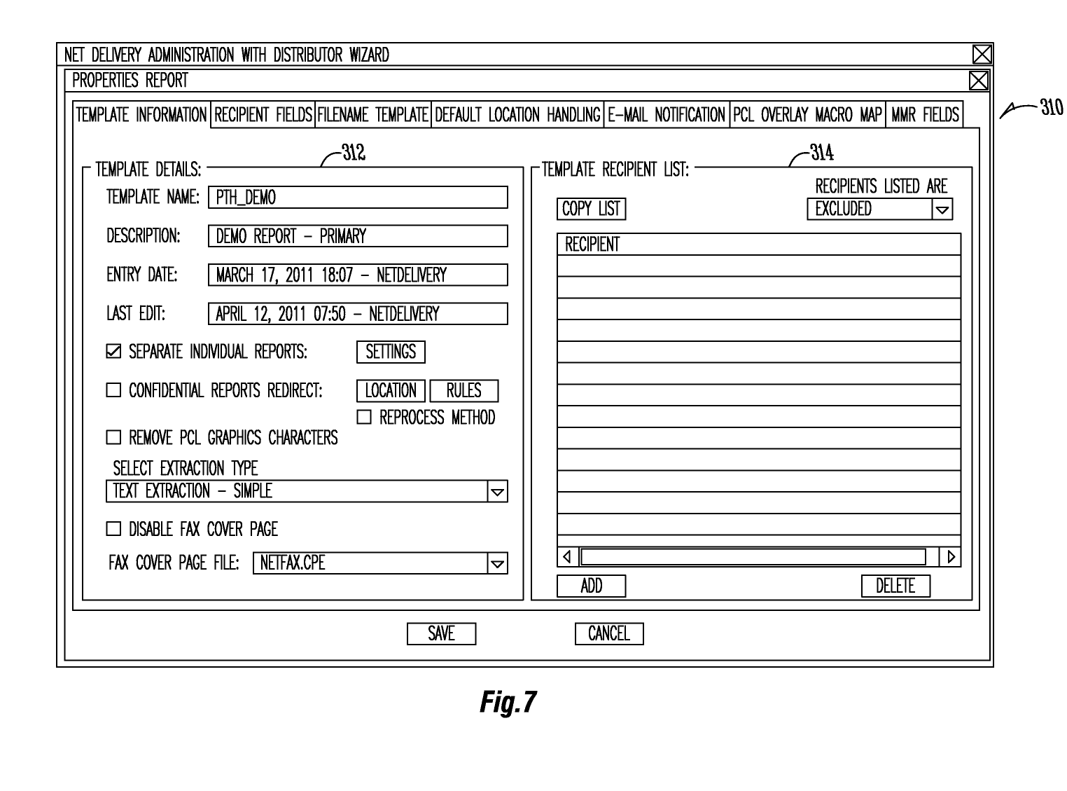

FIG. 7 further illustrates a screen display 310 showing template information for a report. Template details 312 are shown as well as a template recipient list 314.

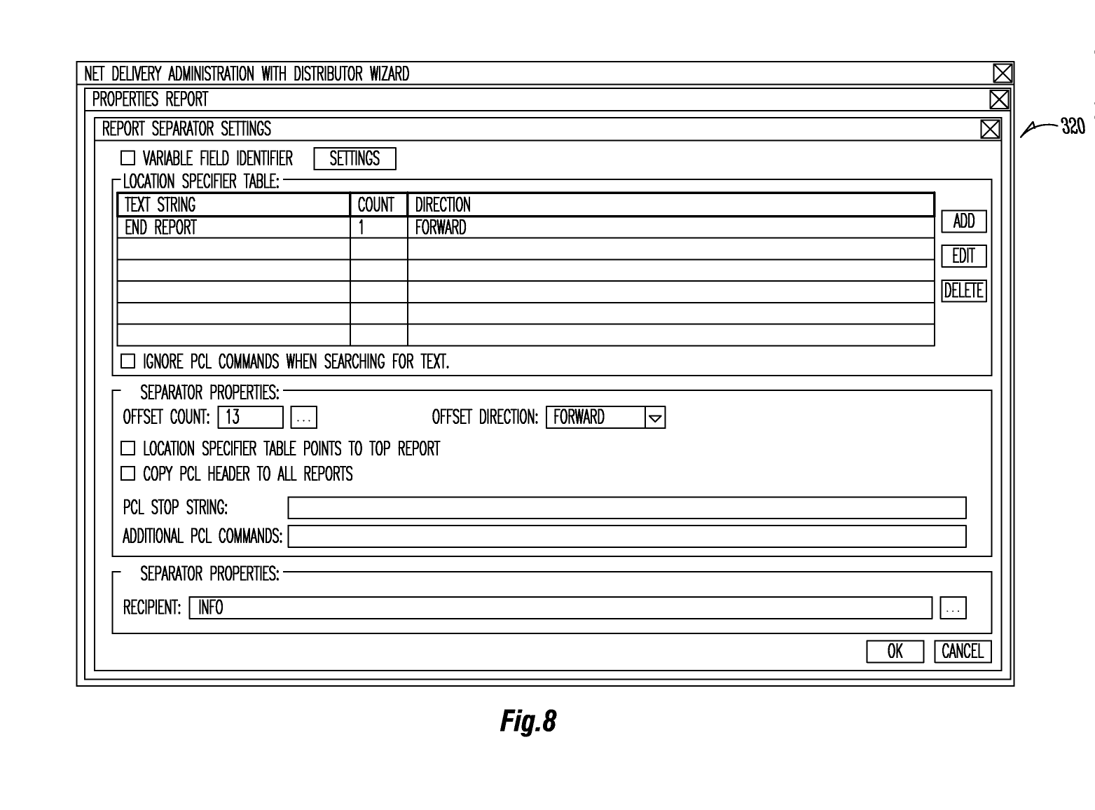

FIG. 8 illustrates a screen display 320 showing report separator settings.

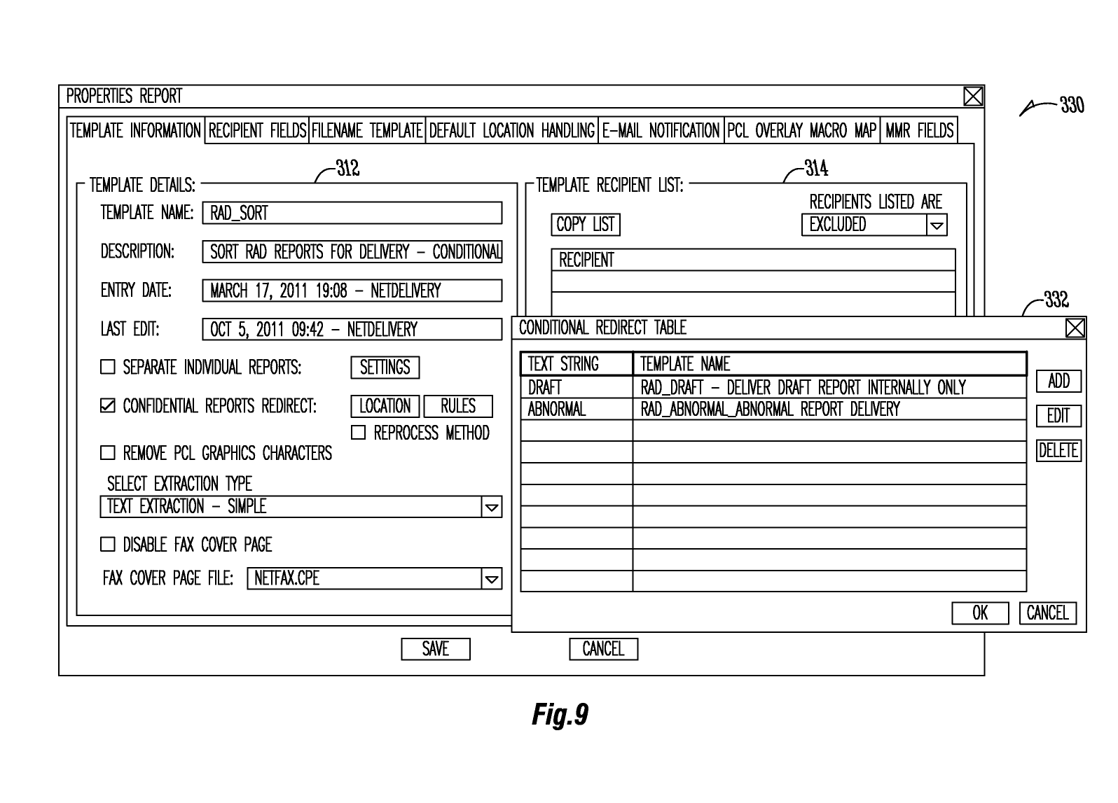

FIG. 9 illustrates a screen display 330 showing template details 312, a template recipient list 314, and a conditional redirect table 332. The conditional redirect table 332 provides a method for redirecting the delivery of a report under a specified condition.

FIG. 10 illustrates a screen display 340 showing a filename template 342. Note that filenames can be built using data fields so that filenames can include extracted data values.

FIG. 11 illustrates a screen display 350 showing that data can be transmitted in or out on defined TCP sockets.

FIG. 12 illustrates a screen display 360 illustrating that a message can be delivered as HL7.

FIG. 13 illustrates a screen display 370 showing that transactions can be logged into one or more databases 372.

Therefore, it is to be understood that various methods and systems are provided for the exchange of health information, including the ability to send information from an electronic health record or electronic medical record associated with a health care information system and ultimately transfer that information into a personal health record. Moreover, provisions are made that allow for the electronic health record or electronic medical record to be preserved in an image file format. Furthermore, provisions are made that allow for data to be extracted from the electronic health record or the electronic medical file regardless of its format.

Thus, various methods, apparatus, and systems for the delivery of electronic medical records or electronic health records to a personal health record portal have been disclosed. Although specific embodiments have been shown and described, it is to be understood that the present invention contemplates numerous variations, options, and alternatives. For example, the present invention contemplates that any number of types of health care information systems may be used, the present invention contemplates that EMR/EHR reports may be provided in any number of formats, where used, the destination address may be a phone number or email address or other identifier, different types of templates may be used to assist in report distribution, different logic may be used to route reports, and other variations, options, and alternatives.

What is claimed is:

1. A method for delivery of electronic medical records or electronic health records to a personal health record portal, the method comprising:
sending an electronic health record or electronic medical record from a health care information system to a report distribution system;
generating a report using the report distribution system; and
distributing the report from the report distribution system to a personal health record portal accessible through a web server.

2. The method of claim 1 wherein the step of distributing the report from the report distribution system to the personal health record portal comprises sending the report to a destination address associated with a user account.

3. The method of claim 2 wherein the destination address comprises an email address.

4. The method of claim 2 wherein the destination address comprises a phone number.

5. The method of claim 1 further comprising receiving a request form from a patient specifying that records of the patient be sent to the destination address.

6. The method of claim 1 wherein the step of distributing the report from the report distribution system to the personal health record portal comprises sending the report to a fax server operatively connected to the web server.

7. The method of claim 1 wherein the step of sending comprising printing the electronic health record or electronic medical record to a virtual printer, the virtual printer configured to communicate the report to a delivery server.

8. The method of claim 1 wherein the step of distributing the report comprises distributing the report according to a report distribution template.

9. The method of claim 1 further comprising using the report distribution system for performing steps comprising:
receiving the electronic health record or electronic medical report as an input file;
determining a format of the input file and if the format of the input file is not a text format, converting the input file into a text format input file using a computing device;
extracting data corresponding with one or more data variables from the text format input file using the computing device;
assembling a file for delivery using the data;
and wherein the step delivering the file for delivery to the web server to thereby make the health information available at the personal health record portal.

10. The method of claim 9 wherein the step of assembling the file for delivery using the data comprises using a template with the one or more data variables.

11. The method of claim 9 wherein the file for delivery comprises an image file.

12. The method of claim 9 wherein the file for delivery comprises an HL7 message.

13. A method for delivery of electronic medical records or electronic health records to a patient portal, the method comprising:
receiving an input file containing health information from a health care information system;
determining a format of the input file and if the format of the input file is not a text format, converting the input file into a text format input file using a computing device;
extracting data corresponding with one or more data variables from the text format input file using the computing device;
assembling a file for delivery using the data;
delivering the file for delivery to a server associated with a patient portal to thereby make the health information available at the patient portal.

14. The method of claim 13 wherein the file for delivery comprises a HL7 message.

15. The method of claim 13 wherein the file for delivery comprises an image file.

16. The method of claim 15 wherein the image file is a PDF file.

17. The method of claim 13 further comprising logging one or more transactions associated with the method.

18. A system for delivery of electronic medical records or electronic health records to a personal health record portal, the method comprising:
a report distribution system comprising instructions stored on a computer readable storage medium and executing on a computer device for performing steps of receiving an electronic health record or electronic medical record from a health care information system, generating a report, and distributing the report to a personal health record portal accessible through a web server.

19. The system of claim 18 wherein the receiving is receiving the electronic health record or the electronic medical record as an input file.

20. The system of claim 19 wherein the step of generating the report comprises determining a format of the input file and if the format of the input file is not a text format, converting the input file into a text format input file, extracting data corresponding with one or more data variables from the text format input file, and assembling a file for delivery using the data.
